(19) United States
(12) Patent Application Publication
(10) Pub. No.: US 2013/0246289 A1
(43) Pub. Date: Sep. 19, 2013

(54) APPARATUS FOR DRAWING ELECTRONIC CONTRACT USING COMMUNICATION NETWORK AND METHOD THEREOF

(71) Applicants: Je Hyoung Ryu, Daejeon (KR); Nam Gu Ryu, Daejeon (KR)

(72) Inventors: Je Hyoung Ryu, Daejeon (KR); Nam Gu Ryu, Daejeon (KR)

(73) Assignee: Je Hyoung RYU, DAEJEON (KR)

(21) Appl. No.: 13/702,798

(22) PCT Filed: Jun. 29, 2012
(86) PCT No.: PCT/KR12/05205

§ 371 Date: Dec. 7, 2012

(30) Foreign Application Priority Data
Jun. 29, 2011 (KR) 10-2011-0063513
Jun. 29, 2012 (KR) 10-2012-0070521

(51) Int. Cl. G06Q 30/00; G06Q 50/18

(52) U.S. Cl. CPC G06Q 30/018; G06Q 50/18
USPC 705/311

(57) ABSTRACT

The device and its methods, and how the invention's purpose is to input for electronic contracts using a communications network will be introduced.

The present invention uses a communications network as a medium and proves contract application from the service server.

When the received contract application is activated, a control medium is used to synchronize the terminals of involved electronic contract parties via the terminal set synchronization code. When the terminals are synchronized, display of notification icons to let the other involved party know of input fields within the electronic contract.

### TECHNICAL FIELD

The present invention is in accordance with creating electronic contracts, its methods, especially, the sharing of contracts in real time with affiliated partners of the shared terminal by using the set synchronization code. Also, providing precautions and mandatory information input for the contract and also inputting additional information in regards to verifications when the contract is done via a communications network.

### BACKGROUND OF THE INVENTION

Electronic signatures, electronic certifications, and the language used in the certification are a product of neologism and have been developed much to advancements in the internet.

The above terminology is affiliated with the person involved verifying that he or she is the actual person via certification, and accurately portrays the contract relations that are due to actions of financial and non financial activities off and online. Also, this involves methods of inputting electronic contracts and in relations to creating proof for future legal issues that may arise.

As in the past, the method was as follows, one side of the party agrees with the other involved party and inputs the electronic contract, and inputs an electronic signature, after that, he or she sends an email and the recipient checks the electronic contract, inputs an electronic signature and sends it to a notary.

In detail, involved parties and notary receive a certificate from certified institutions such as, the Korean information certificate authority, Korea financial telecommunications and clearings institute, Koscom, etc. After that, one of the party members in agreement with the parties involved inputs an electronic contract and signature and emails this to the other party. Upon receiving the email, the recipient scrutinizes the email and after careful scrutiny, evaluates if the email was sent by the correct party, after, the input of the electronic signature evaluates once more if it is the correct party.

If there are no visible issues with the electronic contract & signature, the involved party inputs the electronic signature and sends this to the notary via email.

When the notary receives the email from the involved party and carefully scrutinizes over it, and evaluates that there are no problems, he or she inputs an electronic signature into the electronic contract and sends it to the involved parties.

However, the above mentioned method is sophisticated and has many complications, such as, due to the parties involved having little or no information as to what they have to input into the electronic contract, he or she may have to make phone calls to make queries or check the internet for possible answers.

This calls for various solutions to quicker and easier solutions involving electronic contracts.

### FIELD OF INVENTION

### Task that Requires Solving

The present invention is in accordance with creating electronic contracts, its methods, especially, the sharing of contracts in real time with affiliated partners of the shared terminal by using the set synchronization code. Also, providing precautions and mandatory information input for the contract and also inputting additional information in regards to verifications when the contract is done via a communications network.

However, the invention is not limited to what is stated above and, other purposes have been stated below for the reader to be fully aware and comprehend.

### Solutions

To achieve the purposes mentioned above, the mentioned invention's one aspect is that the utility to input and create electronic contracts, is a form of communication that is provided through a application that is utilized to create electronic contracts.

When the application is active, it is a way of controlling the other involved party's terminal by using the set synchronization code. Also, if it is synchronized with other sharing involved parties, it also displays the input areas of the other involved party's contract.

Advisably, the above mentioned control method has a special feature of being able to share information through the communications method through the terminal when information for the input is put in via information received by the user in charge of the input contract information.

Advisably, the above mentioned method of control has a feature where it checks to see if there are any mandatory input areas or precautions that need to be taken and lets you know through a display of icons.

Advisably, the above mentioned method of control has a feature where, when all the information has been put in, depending on the users input control, the user receives certification information that is set on the terminal, and then receives location information. With the location and certification information as a basis, the user's certification operation is sent to the service server, and when the service server receives the information on the results, the server registers the electronic contract.

Advisably, when the above mentioned control method evaluates that the certification of the user has been verified, the finished contract is then registered at the present service server.

Advisably, when the above mentioned service server's certification information is an authorization certificate, it is linked with the authorization certification server and goes through a phase 1 verification, when this is successful, it goes through a phase 2 verification, where it checks and compares if the location information set in the terminal is within in the active area. When this is done, it is evaluated that the verification is successful.

Advisably, when the service server's certification information is an electronic signature, it goes through a phase 1 verification process where it checks to see if the electronic signature set within the terminal is unanimous. Then it goes through a phase 2 verification processes, where it checks to see if the location information set within the machine is within the active area. When the results are compared and it is evaluated as successful, the whole process is evaluated as successful.

Another aspect of this invention in regards to input of the electronic contract is that when the electronic contract application is active, a step that is taken is for the use of the set synchronization code to synchronize with the contracts involved party terminals. When this is done, the next step that is taken is to input information for the contract. When this is complete, it is linked in with the service server upon receiving location and verification information, and then undergoes verification. After successful verification, the final step is for the service server to register the contract.

Advisably, synchronizing the electronic contract via the set synchronization code that is displayed on the screen; sending of the code to involved parties; after sending the code, checking of the received code by the other involved party; checking if the synchronization code is unanimous with the other.

Advisably, the input of the electronic contract requires that after synchronization, selection of one format of contract among various contracts; input of information with the selected contract format; after inputting the received information, checking if there are mandatory input & precautions that need to be taken; signaling if there are any precautions or mandatory input information that needs to be put in; after the selection of a specific warning icon, displaying of the specific sign if required.

Advisably, when the inputting of information for the electronic contract is complete, depending on the users input capabilities, inputting the set certification information; and when verification information has been put in, involved parties will receive location information.

Next, upon receiving the location & certificate information, sending it to the service server for verification; receiving the verification success information from the service server.

Another aspect of the electronic contract is, after the application becomes active, using the synchronization code, synchronizing the involved party's terminal using the synchronization code; next, after the inputting of the electronic contract with the involved party is complete, carrying out obligations regarding the verification from the service server; after receiving relevant verification information, sending that information to the involved party's terminal; also, depending on the received information, if it was successful, registering the electronic contract to the service server.

Advisably, after synchronization, inputting the code that is displayed on the electronic contract screen; sending of the synchronization code to the involved party's terminal; after sending the synchronization code, receiving information that the involved party has received the synchronization code, next, checking of the received confirmation message in relations to the synchronization code, then, checking if the synchronization code is unanimous to the involved party. Desirably, the inputting of the contract is done when the involved party's terminal is synchronized and, selection of the type of contract format from a list of contract formats; indicating the input article from the selected format; after inputting the information received from the user, checking of the mandatory information & precautions; signaling if there are any precautions or mandatory input information that is needed; also, after the signaling icon is selected, signaling precaution and mandatory information that is required.

Advisably, the process for claim is done after the inputting of the electronic contract and, depending on the users input capability, receiving input of the set verification information; after receiving the input information, receiving the location information; sending the received location & verification information to the related service server.

Advisably, when the above mentioned service server's certification information is an authorization certificate, it is linked with the authorization certification server and goes through a step 1 verification, when this is successful, it checks and compares if the location information set in the terminal is within in the active area. If the above information is compared and phase 2, verification is successful, it sends a message to the involved party that the verification was successful.

Advisably, when the above mentioned service server's certification information is an authorization certificate, it is linked in with the authorization certification server and goes through a step 1 verification, when this is successful, it checks and compares if the location information set in the terminal is within in the active area. If the above information is compared and phase 2, verification is successful, it sends a message to the involved party that the verification was successful.

### Effects of the Invention

Through this process, the present invention strives to share real time electronic contract information through the synchronization of exchanging codes for fair and quick electronic contract information input.

Furthermore, this invention also displays precautions and mandatory information input in relations to the electronic contract, in order to evade unfair and unjust actions.

### BRIEF DESCRIPTION OF THE DRAWINGS

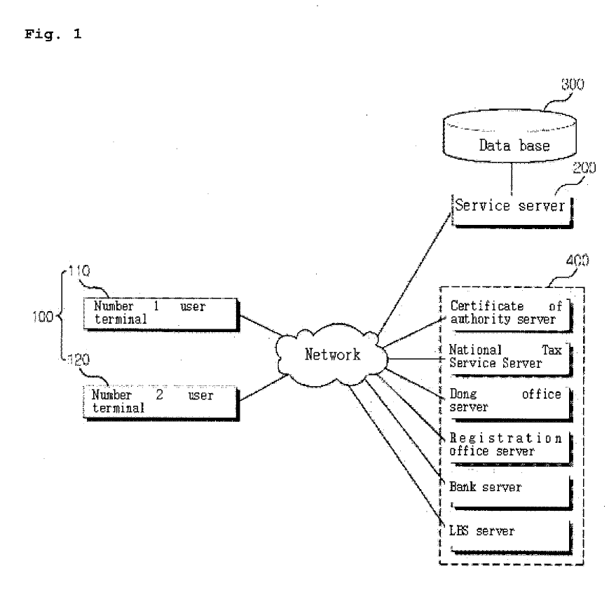

In accordance to our exercised record, FIG. 1 is a figure that shows the system for the input of the electronic contract.

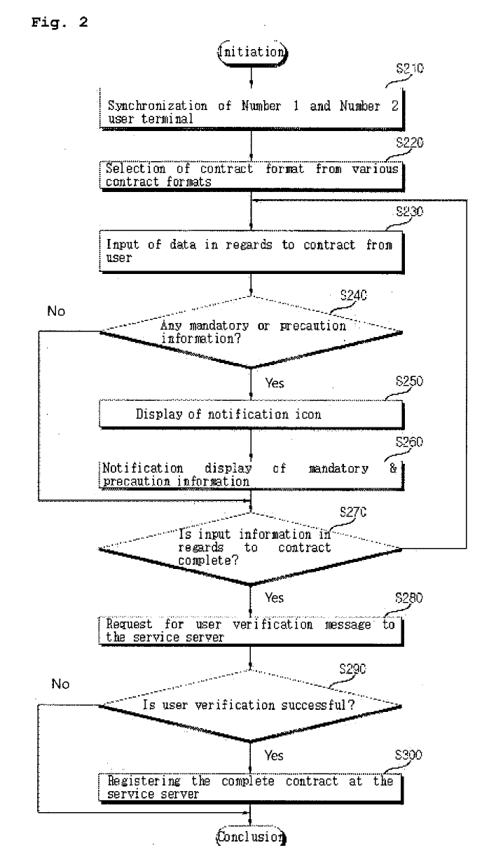

In accordance to our exercised record FIG. 2 shows the method for electronic contract input.

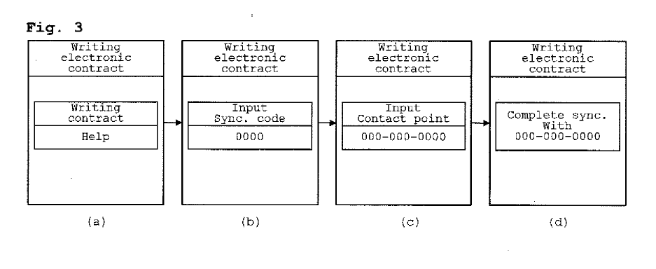

In accordance to our exercised record FIG. 3 shows the method for synchronization between terminals.

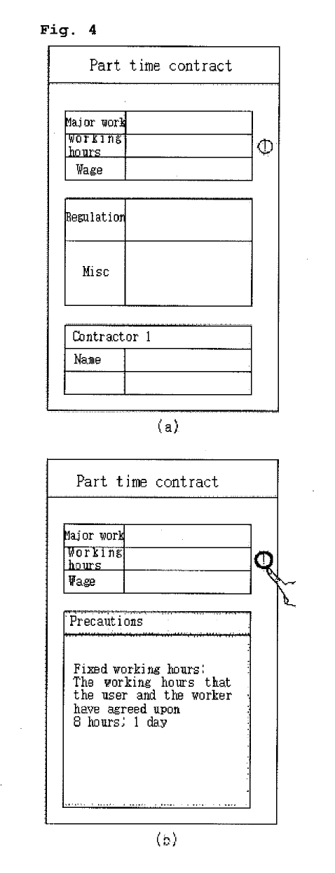

In accordance to our exercised record FIG. 4 shows displays contract input methods.

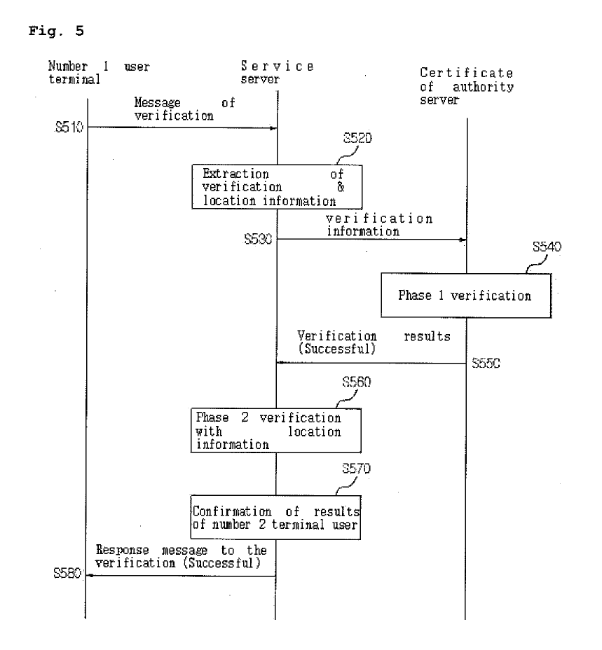

In accordance to our exercised record FIG. 5 picture 1 shows methods to carry out verification processes.

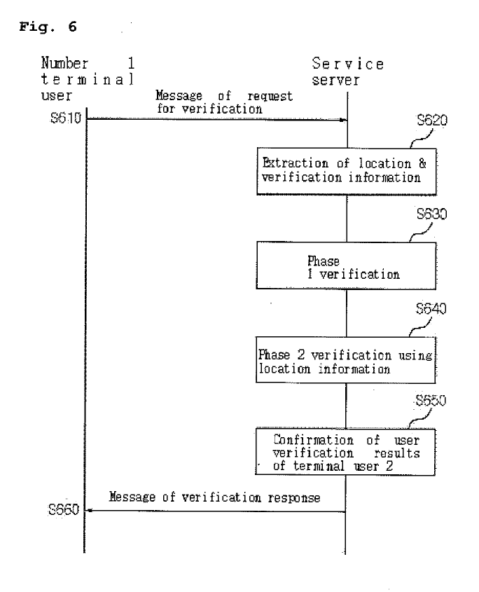

In accordance to our exercised record FIG. 6 number 2 shows methods to carry out verification processes.

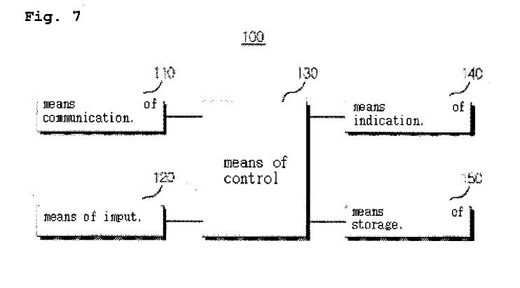

In accordance to our exercised record FIG. 7 shows specific aspects of user's terminal.

### SPECIFIC DETAILS FOR APPLICATION OF INVENTION

In accordance to our exercised record, FIG. 1 or 7 describes equipment and methods for input of electronic contracts via a communications network system.

Describes in detail the functions and applications of the invention for ease of comprehension.

Also, in explaining the inventions aspects, we can give different reference symbols, and, even though they are different figures, we can give it the same reference symbol.

However, despite the situation, the components, in accordance to our exercised record, defines that they have different functions, OR in accordance to different exercised records, can have the same functions. The functions in each component have to be evaluated on the basis of each exercised record of each component.

Also, in explaining the components of the invention, terminology of number 1, 2, A, B, (a), (b) can be used.

The terminology is there to differentiate between different components, and does not limit or change the nature and order of the related component.

Some components may state, ‘connect’, ‘link’, or ‘unify.’ This may actually mean directly connecting the components, however, there may be a medium that ‘connects’, ‘links’, or ‘unifies’ the components.

Especially, the involved parties share the information by synchronizing the terminals through the synchronization codes, and also, provide information on precautions and mandatory input information and propose new methods to input set verification information upon receiving verification information after the completion of the electronic contract.

In accordance to our exercised record, FIG. 1 is a figure that shows the system for the input of the electronic contract.

As shown in FIG. 1, the invention's electronic contract input system is formed of system user terminal (100), service server (200), database (300), and collaborated server (400).

The user terminal (100) is linked in with the service server (200) for input of electronic contract between parties. The user terminal downloads the application through the service server (200), and applies it for electronic contract input.

At this point, for example, the user terminal (100) can cover cell phones, smart phones, laptops, digital broadcasting equipment, PDA's, PMP's, cameras, navigation systems; tablet PCs, e-books, etc.

The user terminal (100) can be classified as a means of electronic contract input shared between at least a number 1 and number 2 users.

In other words, we can state that a user possessing a terminal (user 1) shares electronic contract information with a (number 2) 120 terminal user. So, when one user inputs information or changes information within the electronic contract, it is shared with the involved party.

So, if user 1 (110) and user 2 (120) does not synchronize with each other, information within the electronic contract cannot be shared.

The terminal user (100) whist inputting information within the electronic contract can provide information in regards to precautions or mandatory input information.

At this point, precautions comprise of obligations and rights, so, it can display aspects such as, part time job hours & minimum wage.

These types of precautions provide not only legal information, but, examples of issues that are high in frequency in video or text format.

For example, when inputting a service contract, ‘Contractor ‘A’ person who is the ordering body & person ‘B’ who is the receiver of the contract and the person who is performing the given task.

Please input the relevant person's personal data ‘A’ OR ‘B.’ Directions will follow.

Another example would be in instances such as a labor contract where, ‘the legal minimum wage is since 2009, 4000\ per hour.’ This sort of notification would be present in order to limit unfair and unjust contract procedures.

Also, mandatory information input would be aspects such as, real estate transactions where, certified copy of register would be displayed. This type of mandatory information input would be provided with links where you can procure by entering outside collaborated servers.

For example, in regards to mandatory information input, when you need to check the registration, you can connect to the registration server link and search and check the required information.

Another example is, when you need to check for wire transfer information, you can click the link, and connect to the bank server where you can check the account balance information.

The aspects of mandatory information input, depending on the setting, is achieved and can only move on to the next subject where and when the involved party has made a final check, and has input data that confirms that they have made a final check.

Through this, this invention can prevent the root of legal conflict in regards to contracts and recognize fraudulent acts.

After the completion of the contract, Terminal user (100) can then, together with the verification information, plus the additional set verification information, confirm and recognize all necessary data.

At this point, verification information contains information such as, electronic signatures, official certificate of authorization, etc.

Also, verification information is such as, audio or video data that has been recorded OR fingerprint and iridodiagnosis information, visual recognition, blood recognition, etc. All information that can be proof, that the involved party has confirmed or has not confirmed.

Furthermore, verification information is present indirectly in order to prevent fraud and plagiarism. For example, terminal user (100), and its location information.

The service server (200) which deals with various types of electronic contracts provides the user terminal (100) with contract applications and other things of such nature via wireless or cable connection.

The service server receives certification and verification information which verifies the information as a basis and sends that information to the user terminal.

At this point, the service server (200) either, verifies the information independently or, through a collaborated network (400) by linking systems and can carry out the service.

Especially, the service server evaluates the verification as a success when all involved parties have been verified, and then the contract user verification can be stated a success.

The database (300) which deals with various electronic contracts can store contract applications.

The collaborated network server (400) links with the user terminal (100) to provide information on contract input and files those are necessary.

The collaborated network system (400) deals with information such as, certificate of authorization server, National tax service server, office of Dong server, registry server, bank server, LBS (Location based service) server, etc.

In accordance to our exercised record FIG. 2 shows methods in order to input into electronic contracts.

As shown in FIG. 2, the electronic contract that is desired to be carried out input, is synchronized with involved party number 1 user terminal (110), and number 2 terminal users (120).

In accordance to our exercised record FIG. 3 shows methods to synchronize between terminals.

As shown in FIG. 3, (a) firstly, terminal user (110) in order to input electronic contract activates the application, and the necessary input fields are selected by the user.

(b) Number 1 terminal user (110) after receiving the necessary input fields, inputs the number 1 synchronization code into the synchronization code field.

At this point, the synchronization code consists of numbers, symbols, texts', images, etc.

(c) The number 1 user terminal (110) receives contact information for synchronization with number 2 user (120).

Then, number 1 terminal user (110) upon receiving contact information sends the synchronization code to the number 2 terminal user.

(d) When the number 2 terminal user (120) inputs the synchronization code, number 2 terminal user receives a message in order to be notified of the second synchronization code.

When the confirmation message is received, number 1 terminal user (110) checks whether to be aware if both the first and second synchronization codes are unanimous. When this is done, depending on the results, a notification message will be displayed to be let known if the synchronization. is successful.

Also, number 1 terminal user sends a message to notify if the terminal synchronization has been successful to number 2 terminal user. Another message will be displayed if the number 2 terminal user's synchronization is successful.

When the number 1 (110) and number 2 (120) terminal user synchronization has been completed, the information can be shared due to the involved parties sending each other input information in regards to the electronic contract.

In other words, the number 1 terminal user (110) actually inputs information in the electronic contract, however, the number 2 terminal user (120), is sent the information that is being input in real time.

However, if terminal user 1 (110) and terminal user 2 (110) are not synchronized, the electronic contract information cannot be shared in real time, and the contract is not evaluated as legitimate so the contract is not allowed access to input information in the electronic contract.

In other words, when this transpires, a notification will be displayed to once again synchronize number 1 terminal user and the number 2 terminal user.

Next, the number 1 terminal user (110) can select the type of contract at random from the various types of contracts that are stored.

At this point, when the contract format is selected by the user terminal (120), he or she will notify user terminal number 2 (120) in whereas number 1 terminal user will select the same format.

Next, the number 1 terminal user (110) displays the selected contract and is able to input information that has been provided by the user in the necessary input fields. (S230)

Next, the number 1 terminal user 110 is able to check if there are any precautions or mandatory input fields that are required (S240).

After checking to see if there are any precautions or mandatory input fields, number 1 terminal user (110) can display a notification sign that will let the involved party know that there are precautions or necessary input fields that requires input.

Next, when the number 1 terminal user (110) selects a particular notification icon, he or she can display a notification message that is correspondent to the specific matter (S260).

In accordance to our exercised record FIG. 4 shows the electronic contract being put in.

As shown in FIG. 4, the number 1 terminal user can select a specific notification icon in regards to the precaution or mandatory input field information within the contract.

This invention harbors a number 1 icon that notifies precautions, and a number 2 icon that notifies mandatory input fields.

(a) A notification icon for precautions and mandatory input field is displayed on the side of the screen for number 1 terminal user in regards to electronic contract input fields.

(b) When the number 1 terminal user (110) selects a notification icon, it will be displayed depending on what the notification is in regards to, either mandatory input fields or precautions.

At this juncture, number 1 terminal user (110) is synchronized with number 2 terminal users (120), so the notification icons that are displayed towards number 1 terminal user (110) can be seen by number 2 terminal user 120 as well.

At this point, if the user does not confirm that he or she has checked the precautions or mandatory input fields, the electronic contract application de activates itself so that no more information can be put in. In other words, both number 1 and number 2 terminal user needs to check their terminals of the notifications.

Next, the number 1 terminal user (110) can check to see if all the input fields have been put in, in regards to the contract (S270).

In other words, when the number 1 terminal user (110) has confirmed and the contract is complete in regards to this, he or she receives verification information input from the user, and receives location information.

Next, number 1 terminal user creates a verification request message and is able to send this to the service server which contains both verification information and location information for verification by the user.

In other words, a verification request is sent by number 1 terminal user for verification by the service server which is based on the verification information and location information (S280).

Next, number 1 terminal user (110) can evaluate if the verification process is successful by receiving a message from the service server in regards to if the verification was successful by the service server (S290).

Next, when the number 1 terminal user (110) receives a response message in regards to the verification, he or she can send the complete electronic contract to the service server for registration (S300).

The number 1 terminal user (110) will indeed save the complete electronic contract within the internal memory.

In accordance to our exercised record FIG. 5 shows methods for user verification processes.

As shown in FIG. 5, if number 1 terminal user wishes to verify with a certificate of authorization, he or she creates a message of request of verification to the service server which includes information in regards to location information and verification information (S510).

At this point, number 1 terminal user can receive location information by linking into the LBS server.

Next, when the service server receives a request of verification information from the number 1 terminal user, the service server extracts location and verification information from the message received from the number 1 terminal user (S520) and, can send the verification information to the certificate of authorization server (S530).

Next, the certificate of authorization server on the basis of the verification information can carry out verification (S540) and send that information to the service server (S550).

For example, the certificate of authorization server can inspect to check if the password for the certificate of authorization is unanimous to the password that is set within the terminal and this will conclude phase 1 of the inspection for verification.

Next, when the service server concludes successful phase 1 verification, the service server will continue phase 2, verification with the location information as a basis (S560). For example, the service server will conclude the verification as successful when the user's location is unanimous to the active area set in the terminal.

At this point, the user appoints an active area within a certain boundary where he or she works, for example, a house or office and saves this. For instance, this may be an area within a 1 kilometer radius.

The number 1 terminal user can check if he or she is within this radius and also check through the terminal if the number 2 terminal user is within the same boundary.

Also, the invention will provide information to which it notifies if the number 1 and number 2 terminals are in the same applicable area, and if so, then the 2nd phase verification is evaluated as successful.

Next, when the service server is successful with the 2nd phase verification, at least one of the number 2 terminal user who is involved in the electronic contract confirms the verification process (S570). After checking, if all verifications are successful, with the response message he or she can create a response message that confirms the success of the verification and send it to the number 1 terminal user's terminal (S580).

Indeed, the verification confirmation message has to be sent to at least more than one number 2 terminal user (S580).

In accordance to our exercised record FIG. 6 shows the method in which describes user verification.

As shown in FIG. 6, when an electronic signature is used for verification, number 1 terminal user creates a verification request message which includes location information and verification information to the service server (S610).

Next, when the service server receives the verification request message from number 1 terminal user, the service server can extract information from the message which includes location and verification information (S620).

Next, the certificate of authorization server can carry out phase 1 verification with the extracted verification information as a basis.

For instance, the certificate of authority server inspects if the electronic signature and the terminal set electronic signature are unanimous, and if it is unanimous then the verification is evaluated as successful.

Next, when the service server is successful in regards to phase 1, verification, it conducts phase 2 verification with the location information as a basis (S640).

For example, checking if the user's location is unanimous to the active region and if it is then the phase 2, verification is considered successful.

At this point, the user designates his or her active region, for example, a house or office in the terminal as the area within where he or she is active.

For example, the active region will be within a radius of 1 kilometer.

Next, when the service server is successful with the 2nd phase verification, then there is an inspection of a number 2 terminal user who is involved with the electronic signature (S650), with the confirmed results, if all is successful, in response to the verification request message, a response message is created and sent to the number 1 terminal user (S660).

Indeed, the service server will send the response message to at least one number 2 terminal user.

In accordance to our exercised record, FIG. 7 shows the specific structure of the user terminal.

As shown 100 in FIG. 7, the invention consists of, means of communication (110), means of input (120), means of control, means of indication, means of storage, etc.

The means of communication (110), transmits and receives various data through cable and wireless networks.

For example, the means of communication (110) transmits and receives information with the user terminal in regards to information such as contract input, requesting and receiving user verification messages from the service server, receiving and transmitting diverse information by linking with the collaborated server.

At this point, the means of communication (110), consists of mobile communication modules, wireless internet modules, short distance communication modules, etc.

1) The mobile communications module is a module that can transmit and receive signals through wireless networks with at least one server. This server includes base stations & outside terminals.

2) The wireless internet module is a module for wireless internet connection. This wireless Internet module can be stored and save both internally and externally.

3) The short distance module is for communication within a short distance. Short distance communication technology consists of, Bluetooth, Radio frequency identification (RFID), Infrared Data Association, Ultra wideband UWB, Zigbee, etc.

Means of input (120) can receive input information from the user. For example, the means of input (120), receives input of required input fields within the electronic contract.

The means of control (130) links in with all mediums within the terminal to take control. For example, depending on the user's preference, he or she can apply the electronic contract application and can display this as a means of indication.

The means of control (130) when information is input which has been received from the user, controls and helps send this information to the involved party of the contract and user through the means of communication (110).

The means of control (130) when information is input which has been received from the user, checks to see if there are any precautions or mandatory input information that is required within the already input information, and can control to indicate if there are any precautions or mandatory information input that is required as a display icon.

The means of control (130) after it has completed input of all information within the contract, receives input of set verification information, when this is done, receives location information, requests verification to the service server with the received verification and location information as a basis. After receiving the results of the verification from the service server, the complete contract can be sent to the service server for registry.

The means of indication (140) depending on the application of the electronic contract application, can display the contract. The means of indication (140) deals with precautions and mandatory input information within the contract, and can display this information.

At this point, an example of means of indications (140) would be, Liquid Crystal Display; LCD, Thin Film Transistor Liquid Crystal Display; TFT LCD, Organic Light Emitting Diode; OLED, Flexible Display, 3D Display.

The means of storage (150) can save not only contract applications, but data that will be used as verification information and information in regards to certificate authority.

In accordance to our exercised record the description of the invention states that the combination of all the structured aspects is not limited to the inventions exercised records.

In other words, within the inventions purpose, all the structured aspects can be combined with more than one for application.

Also, all the structure aspects can be seen as an independent hardware, a part of a separate aspect or the whole can be combined and can function as a part or whole in regards to a computer program that harbors as a program module.

Also, this type of computer program which can be read from the computer as a computer readable media, including, USB memory, CD, Flash memory, etc is saved and utilized by the computer and seen as an exercised record.

Computer program storage medium includes recovery memory, optical recording medium, carrier wave medium, etc.

Also, terminology which includes technological and scientific terms, which, if not defined differently, is normally comprehended as the same by intellectuals of this field.

Language as defined in the dictionary and used in normal circumstances has to be defined unanimously in the related technological context, and if not properly defining the invention cannot be defined as ideal or formal.

In relations to past examples, if he or she has knowledge in the associated invention's field, then can go through various corrections and changes if the nature and characteristics of the invention are not altered.

Therefore, the past examples are not to limit the invention's technological ideas but to explain the idea's.

### DESCRIPTION OF KEY SIGNS

100: User terminal
110: Means of communication
120: Means of input
130: Means of control
140: Means of indication
150: Means of storage
200: Service server
300: Database
400: Collaborated server

1. an electronic contracts writing device, comprising:
a means of communication by receiving a contract application from the service server;
a means of control by utilizing the set synchronization code to synchronizing with another involved party's terminal;
a means of display, when synchronized with the another involved party's terminal, for display input fields of the electronic contract to the other involved party.

2. The electronic contracts writing device according to claim 1, wherein the means of control, when the input information received from the server is put in, transmit the input information to share with other involved user terminals through a communications network.

3. The electronic contracts writing device according to claim 1, wherein the means of control, when the input information received from the server is put in, checks the information entered in and also confirms if there are any precautionary or mandatory input fields and displays notification icons if there are any present.

4. The electronic contracts writing device according to claim 1, wherein the means of control, when the input information received from the server is put in, when the contracts that have been verified and completely input, receives input of verification information and then acquires location information; requests verification from the service server with the location and verification information as a basis and then, after receiving successful verification results, can request registry of the electronic contract to the service server.

5. The electronic contracts writing device according to claim 4, wherein if the user's information has been successfully verified, the means of control register the electronic contract which has completely input to the service server.

6. The present invention, according to claim 4, can undergo phase 1 verification by linking in with the certificate of authority server, if and only if the verification information is a certificate of authority and, when phase 1 verification is complete, undergoes phase 2 verification involving location information and its validity of having to be within the terminal pre set active region; when phase 2 is successful, can evaluate the whole verification process as successful.

7. The present invention, according to claim 4, undergoes phase 1 verification by comparing and confirming if the electronic signature is unanimous to the terminal preset electronic signature, if and only if the verification information is an electronic signature; and if phase 1 is concluded to be successful; undergoes phase 2 verification to check if the terminal preset location information is within the active region; if phase 2 verification is deemed successful, the user verification is concluded to be successful.

8. The following are methods for electronic contract input, involved in a phase wherein, when the electronic contract application is active, is synchronized by using the terminal preset synchronization code and, when synchronized, the electronic contract can begin input; when input is completed, undergoes a second phase which involves, linking in with the service server for user verification, with the location and verification information as a basis, and when the user verification is successful, will undergo a third phase in which, the electronic contract which has completed input is registered at the service server.

9. The following are methods for electronic contract input, according to claim 8, wherein the above synchronization phase involves, input of the terminal preset synchronization code that is displayed on the screen of the electronic contract application; transmitting the data to the other involved party's user terminal, after transmitting the data, conclusively the synchronization code, receiving a confirmation message in regards to the other involved party receiving the message and synchronization code and, after checking if the codes are unanimous, synchronizing the involved user terminals.

10. The following are methods for electronic contract input, according to claim 8, wherein the above electronic contract input phase involves, a phase where and when the involved party's terminals are synchronized, selecting one of many contract formats; displaying of the input fields within the contract of the selected and relative contract and, a second phase involving, confirmation if precaution and mandatory input information is present, after the input information received from the server is put in; a third phase which involves, after confirming the results, displaying of a notification icon to show if there are any precaution or mandatory input field information is present; when the notification icon is selected, the precautions or mandatory input fields are alerted through the notification icons.

11. The following are methods for electronic contract input, according to claim 8, wherein the above procedure involves, a phase where and when the electronic contract has completed input, receiving input of terminal set verification information depending on the users input; acquiring location information after receiving input of the verification information and, transmitting a request of verification message to the service server with the acquired verification and location information included in it; and finally receiving a response message from the service server, in regards to the success of the user verification.

12. The following are methods for electronic contract input; wherein the user terminal and electronic contract application is synchronized, the electronic contract undergoes a phase where the involved party's terminals are synchronized via the terminal set synchronization code; when the terminals are synchronized, undergoes a second phase involving the electronic contract input; when the electronic contracts have completed input, undergoes a third phase by requesting a verification to the service server; the service server then undergoes verification and sends those results to the user terminal and, depending on the received results of the verification, the user terminal can then send the electronic contract that has completed input to the service server for registration.

13. The following are methods for electronic contract input, according to claim 12, wherein the above phase involving synchronization involves a phase of input of terminal set synchronization code that is displayed on the electronic contract application screen; sending the synchronization code to the other involved contract party and, after transmitting the synchronization code, receiving a confirmation message in regards to the synchronization code and, confirming the message and the code; and finally synchronizing the involved party's terminals, if and only if the synchronization codes are unanimous to the terminal pre set synchronization code.

14. The following are methods for electronic contract input, according to claim 12, wherein the input methods involve a phase which involves, selecting a format contract from various formats, when the involved contract terminals are synchronized; displaying of input fields of the selected contract; confirmation of terminal set precaution and mandatory input fields, after the input information received from the user have been put in and, selecting a notification icon to display if there any precautions or mandatory input information are present, and when an icon has been selected, displaying precaution or mandatory information input via the notification icon.

15. The following are methods for electronic contract input, according to claim 12, wherein the above phase involving requesting for verification involves; after the electronic contract input is complete, receiving input of terminal set verification information depending on the user's input; when the verification information has been put in, acquiring the location information and, transmitting a request for verification to the service server which includes the acquired verification and location information.

16. The following are methods for electronic contract input, according to claim 15, wherein the verification information is a certificate of authority, linking in with the certificate of authority server for phase 1 verification; when phase 1 verification is successful, phase 2 verification which involves, checking if the terminal set location information is within the active region takes place, after comparing, if phase 2 verification is concluded as successful, transmitting a verification success message to the user.

17. The following are methods for electronic contract input, according to claim 15, wherein if the verification information is an electronic signature, a phase 1 verification undergoes, this involves checking if the electronic signature and the electronic signature that is set within the terminal is unanimous, after comparing and phase 1 verification is successful, phase 2 verification undergoes, which involves, transmitting a successful verification response message to the user terminal.
